(19) United States
(12) Patent Application Publication
(10) Pub. No.: US 2018/0137547 A1
(43) Pub. Date: May 17, 2018

(54) SYSTEMS, DEVICES AND METHODS FOR CREATING A STANDARD UNIT OF VALUE

(71) Applicant: International Diamond Standard Investment Holdings LLC, Lewes, DE (US)

(72) Inventors: Louis Armand Barnard, Johannesburg, Gauteng (ZA); Clifford Elk, Johannesburg, Gauteng (ZA); Gerhard Kemp, Hermanus, Western Cape (ZA)

(21) Appl. No.: 15/354,827

(22) Filed: Nov. 17, 2016

(51) Int. Cl. G06Q 30/02

(52) U.S. Cl. CPC G06Q 30/0278; G06Q 40/06

(57) ABSTRACT

In an embodiment, a method of creating a standard unit of value for non-uniform commodities, such as diamonds, is provided. The method comprises defining, for a particular diamond cut, a plurality of quality classes and a plurality of carat classes; for each combination of quality class and carat class, creating a list of all qualifying diamonds; normalising the value of the diamonds in the list of qualifying diamonds over a fixed period, sufficient to measure changes of value. This may include the steps of obtaining or determining the monetary value for each of the diamonds in the list, determining the average of all these values, and dividing each value in the list by the average so as to obtain an average relative value for each diamond in the list. The method concludes by selecting a group or parcel of diamonds that collectively, in the aggregate, define the standard unit of value.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Described herein are methods related to standardizing non-uniform objects or assets, and in particular, in one version, to a method of creating a standard unit of value for non-uniform objects, such as diamonds.

### Description of the Related Art

All diamonds are unique, and have traditionally been individually valued by expert valuators and certified by third party gemological laboratories, thus proving illiquid and difficult to trade. As a result of the unique nature of diamonds, they, unlike other commodities, have remained inaccessible to financial investors. In particular, without a standardised product or internationally accepted pricing system, the commodification of diamonds for investment purposes is always going to be limited. This is because, unlike other commodities such as platinum or gold, each diamond has unique characteristics and attracts a differential value. The entire diamond value chain has traditionally been constructed around this fact. Diamonds are identified and valued according to the following general criteria: carat, clarity, colour, and cut (also known as the four C's). With the exception of carat, which is definitive because diamonds can be weighed accurately, the remaining three C's remain subjective and unscientific, and therefore demand for gem quality goods has been limited to the jewelry industry and industrial applications, and so no investment market, save for rare collectables, has been developed. Solutions that overcome these and other drawbacks are therefore needed.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages over existing approaches.

Described herein are methods, devices and systems related to the commodification of non-uniform commodities, such as diamonds. The methods, devices and systems described herein may be extended to cover non-uniform assets in general, such as other commodities, gemstones and financial assets, in respect of which general criteria may be associated with the asset. The general criteria typically drives the value of the non-uniform asset, and these assets typically require a subjective assessment as to their value.

Thus, unique methodologies are provided that can be applied to create a standardised, tradable unit or store of value in order to create a new trade and investment market for non-uniform commodities, such as diamonds, or other objects or assets. One advantage is to simplify the trading of such commodities by setting an acceptable standard reflective of the characteristics that drive the market price of such commodities.

Described herein in some embodiments are gateways to the commodification of non-uniform commodities, such as polished diamonds, and to the development of an open and liquid financial market, by creating a tangible and fungible asset class, together with a trading platform. The asset class may be referred to as the Diamond Currency Unit (DCU), with each DCU having the same market value as a corresponding DCU, except for an acceptable variance, for example of about 0.03%. The methods thus relate to creating standard DCU's of value, with acceptable deviations, based not on a single diamond but on a parcel of diamonds, with the starting point being the determination of the general criteria of the parcels (the four C's in the case of diamonds). Having determined the general criteria, each parcel of diamonds should hold a sufficient, reasonable number of diamonds so as to practically remove as much variability as possible between various parcels. In one embodiment, each parcel may hold ten diamonds.

In use, the plurality (for example ten) of diamonds, which define a sub-set of qualifying polished diamonds, may be selected from a pre-selected universe of diamonds and encapsulated in a tamper proof and secure container. Typically, for practical application depending on available manufacturing technology, only polished and certified diamonds that comply with pre-defined parameters may be considered for selection.

The aim is thus to allow investors to invest and trade in sealed and traceable DCUs, because they are replicated under controlled conditions, are valued using transparent metrics, and their prices are publically quoted with units traded on a world-wide basis. The availability of the DCU and the ease of trade may create the impetus for the growth and development of a non-traditional investment market for polished diamonds, which may compliment the traditional jewelry market.

The described methods thus address the issue of standardisation. A sub-set of acceptable and available polished diamonds may be defined that meet the general criteria for incorporation into a DCU—these may be identified and selected based on the traditional four C's and/or additional criteria. Each diamond is then ascribed a weighted value (or relative value) through the application of a unique value rating methodology to get a list of relative values, and thereafter a standardising algorithm (described in more detail further below) is applied to the entire sub-set to identify and select a plurality (for example, 10) of individual diamonds to be included into a single DCU of aggregated value. If the methodology and algorithm is consistently applied, and the sub-set of available diamonds remain unchanged, then no matter when the DCUs are created, their value in aggregate will remain consistent and standard.

The elimination of the subjective valuation of individual diamonds and the valuing of diamonds on a collective basis, so that the same unit of value (i.e. DCU) can be replicated on a sustainable basis, represents a paradigm shift that makes the creation of a financial market for diamonds possible. The combination of the algorithm for assorting the selection of diamonds makes it possible to package diamonds with consistent and standard values, while simultaneously preventing tampering and product substitution.

The DCU of value proposed by the invention is based on the combined value of a reasonably sized parcel to remove variability in aggregate, for example ten (10) polished diamonds. The diamonds may be commercial quality diamonds that fall within defined parameters, and may not be rare collectible or coloured stones. The parameters may be limited to a predetermined and available range of diamonds. The characteristics of each diamond may be defined by the traditional 4C's (colour, clarity, carats, cut), each being an element of variation. In creating a standardising valuation methodology, it may be necessary to reduce the number of variable elements used in the valuation method and therefore, the algorithm. Eliminating one of the four variables thus makes a solution more easily achievable.

### Cut

One variable that may be controlled, to a large degree, is the ‘cut’ of a diamond. A ‘standard cut’ may be adopted across tradable instruments. In an embodiment, as a practical shortcut, only ‘brilliant-cut’ diamonds may be used, but other cuts may, in addition or alternatively, be used. The ‘cut’ quality may also be kept standard using a predetermined minimum cut value, known as “very-good and up”, also known as “ideal” or “perfect-only.”

By eliminating the cut as a variable, the valuation method becomes three-dimensional, which includes fewer variables than a four-dimensional methodology and pricing matrix, which is traditionally used for diamond valuation.

The diamonds may therefore be assessed for quality only (being clarity and color), since carat mass can be objectively determined and measured by weighing the diamond(s).

### Colour and Clarity

The GIA (Gemological Institute of America) ranks colour alphabetically from ‘grade D (colourless) to ‘grade Z’ (being light yellow). For purposes of the algorithm and therefore the ‘tradable instrument’ to be based on the algorithm, in an embodiment only diamonds of clarity grade D-E-F (colourless) and G-H-I-J (near colourless) would be used. In other embodiments, fewer or more color rankings may be used. Various combinations of color and clarity form a “grading group” (e.g. Alpha, Beta, Gamma, Delta) as per the matrix below (Table 1).

The GIA clarity scale is divided into 6 exemplary groups and 11 exemplary grades, as set out in the following Table 2:

TABLE 2
GIA Clarity Grading

| | |
|---|---|
| Group 1: | FL (flawless) i.e. 1 grade |
| Group 2: | IF (internally flawless) i.e. 1 grade |
| Group 3: | VVS (very very slightly included, which may in turn be |
| | divided into VVS1 and VVS2) i.e. 2 grades |
| Group 4: | VS (very slightly included, which may in turn be divided into |
| | VS1 and VS2) i.e. 2 grades |
| Group 5: | SI (slightly included, which may in turn be divided into SI1 |
| | and SI2) i.e. 2 grades |
| Group 6: | I (included, which may in turn be divided into I1, I2 and I3) |
| | i.e. 3 grades |

Using the colour and clarity gradings shown in Table 1, it is possible to grade and group most investment grade diamonds into one of a plurality of quality classes groups, for example 4 (four) groups, such as Alpha, Beta, Gamma and Delta, as denoted in the two-axis matrix in Table 1. Diamonds in each quality-graded group (Alpha, Beta, Gamma or Delta) may then be sorted into specifically selected carat classes or ‘mass groups’ (weighting groups), for example “3.5 carat”, “5 carat”, “10 carat” and “20 carat”, thus giving, in this example, a total of 16 possible “mass groups”. Each “mass group” is the result of a combination of a plurality of diamonds, for example 10 (ten) diamonds, with a total carat mass of, for example, “3.5 carat”, “5 carat”, “10 carat” and “20 carat”, as shown below in Table 3:

TABLE 3
PERMITTED MASS VARIATION

| Mass Variation Range | | Total Instrument Mass |
|---|---|---|
| Individual Diamonds | | 10 Diamonds |
| (carat) | | (carat) |
| 0.30-0.39 | ×10 diamonds | 3.5 |
| 0.45-0.55 | ×10 diamonds | 5 |
| 0.92-1.12 | ×10 diamonds | 10 |
| 1.75-2.25 | ×10 diamonds | 20 |

In this embodiment, 10 (ten) diamonds are used. In other embodiments, less than or greater than 10 (ten) diamonds may be used. Although each combined DCU of 10 (ten) diamonds in each group comes to a substantially similar or identical value, it must be appreciated that due to the underlying non-uniform (non-standard) nature of each diamond, each DCU (combination of 10 diamonds) may have a mathematically acceptably low variation in value or negligible error margin. For clarification, it is important to understand that there are multiple combinations of 10 in each mass group that will come to substantially the same value. At this stage, the algorithm rejects combinations which have a variance that is too high.

Thus a standardised trading instrument is provided to define an internationally viable asset class. That is, its value must be easily ascertainable by means of a transparent pricing structure that enjoys international acceptance. The ten diamonds incorporated in any DCU must (in this example), for each mass group, produce equal aggregate values (which include an acceptable, negligible error margin) across all units in that particular mass group.

In order to be a successful trading tool, all DCUs (e.g. a combination of 10 diamonds) in a particular mass group must be, within a negligible error margin, identical. The objective is thus to devise an algorithm that will select ten diamonds from a particular weight and quality range without any advantage over any other grouping of ten diamonds from the same weight and quality range. In other words, no one DCU (e.g. a combination of 10) in a given weight and quality class will have any advantage over any other DCU in that same weight and quality class.

Thus, according to a first aspect there is provided a method of creating a standard unit of value for non-uniform commodities, such as diamonds (in which case the unit may be referred to as a Diamond Currency Unit (DCU), the method comprising:

defining, for a particular diamond cut, a plurality of quality classes and a plurality of carat classes;

for each combination of quality class and carat class, create or identify a list of all qualifying diamonds;

normalising the value of the diamonds in the list of possible diamonds over a fixed period, sufficient to measure changes of value, by:

obtaining or determining the monetary value for each of the diamonds in the list;

determining the average of all these values; and

dividing each value in the list by the average so as to obtain an average relative value for each diamond in the list, and

selecting a group or parcel of diamonds that collectively define the standard unit of value.

In an embodiment, the step of selecting the group of diamonds includes choosing a group of diamonds, typically ten diamonds, from the diamond list such that the carat sum of the group of diamonds corresponds to the required carat class.

The method then further includes the step of choosing the groups of diamonds such that the sum of the relative values over the fixed period of each group of diamonds (typically ten diamonds), according to the average relative value list, is substantially the same or identical. This involves comparing the sum of the relative values of the ten diamonds to the value ten, and determining whether the difference is an allowable difference or not.

In an embodiment, once the set of ten diamonds with an acceptable error in its relative value has been determined, the method comprises in addition checking, over a fixed period of time, whether the determined set of ten diamonds does not deviate beyond the acceptable error margin at any point in time during the fixed period of time. This may be achieved, for example, by calculating, for each year within the fixed period of time, for example, ten years, the relative value of the ten diamonds and the error of the relative values of the ten diamonds for each year during that ten year period.

In an embodiment, the method concludes by accepting the ten diamonds if the set is accepted for each year within the fixed period of time.

In an embodiment, the method is computer implemented, and the invention thus extends to a related computer system and computer program product for creating a standard unit of value for diamonds (i.e. DCU). The computer system includes a database with details of available diamonds, including cut, quality class (i.e. quality and clarity) and carat class, with a processing component or module executing a computer program, in conjunction with the database, in order to perform the method of the present invention.

According to a second, more generalised version of the invention, there is provided a method of creating a standard unit of value for non-uniform assets, the method comprising:

defining, for a particular non-uniform asset, general criteria that drive value;

create or identify a list of all qualifying assets;

normalising the value of the assets in the list of possible assets over a fixed period, sufficient to measure changes of value, by:

obtaining or determining the monetary value for each of the assets in the list

determining the average of all these values; and

dividing each value in the list by the average so as to obtain an average relative value for each asset in the list, and

selecting a group or parcel of assets that collectively define the standard unit of value.

In an embodiment, the step of selecting the group of assets includes choosing a group of assets, typically a plurality of assets, from the asset list such that matches the defined general criteria.

The method then further includes the step of choosing the groups of assets such that the sum of the relative values over the fixed period of each group of assets, according to the average relative value list, is substantially the same or identical. This involves comparing the sum of the relative values of the assets to a suitable value, and determining whether the difference is an allowable difference or not.

In an embodiment, once the set of assets with an acceptable error in its relative value has been determined, the method comprises in addition checking, over a fixed period of time, whether the determined set of assets does not deviate beyond an acceptable error margin at any point in time during the fixed period of time. This may be achieved, for example, by calculating, for each year within the fixed period of time, the relative value of the group or parcel of assets and the error of the relative values of the group or parcel of assets for each year during that period of time.

In an embodiment, the method concludes by accepting the group or parcel of assets if the set is accepted for each year within the fixed period of time.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only some embodiments in accordance with the disclosure and are not to be considered limiting of its scope, the disclosure will be described with additional specificity and detail through use of the accompanying drawings. The illustrative embodiments are not meant to be limiting. Other embodiments may be utilized, and other changes may be made, without departing from the spirit or scope of the subject matter presented here. It will be readily understood that the aspects of the present disclosure, as generally described herein and illustrated in the Figures, can be arranged, substituted, combined, and designed in a wide variety of different configurations, all of which are explicitly contemplated and make part of this disclosure.

FIG. 1 shows a schematic block diagram representing a method of creating a standard unit of value for diamonds, according to the invention; and

FIG. 2 shows a schematic block diagram representing a method of creating a standard unit of value for any non-uniform object or asset.

### DETAILED DESCRIPTION

The following detailed description is directed to certain specific embodiments of the development. Reference in this specification to “one embodiment,” “an embodiment,” or “in some embodiments” means that a particular feature or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. The terminology used in the description presented herein is not intended to be interpreted in any limited or restrictive manner, simply because it is being utilized in conjunction with a detailed description of certain specific embodiments of the development.

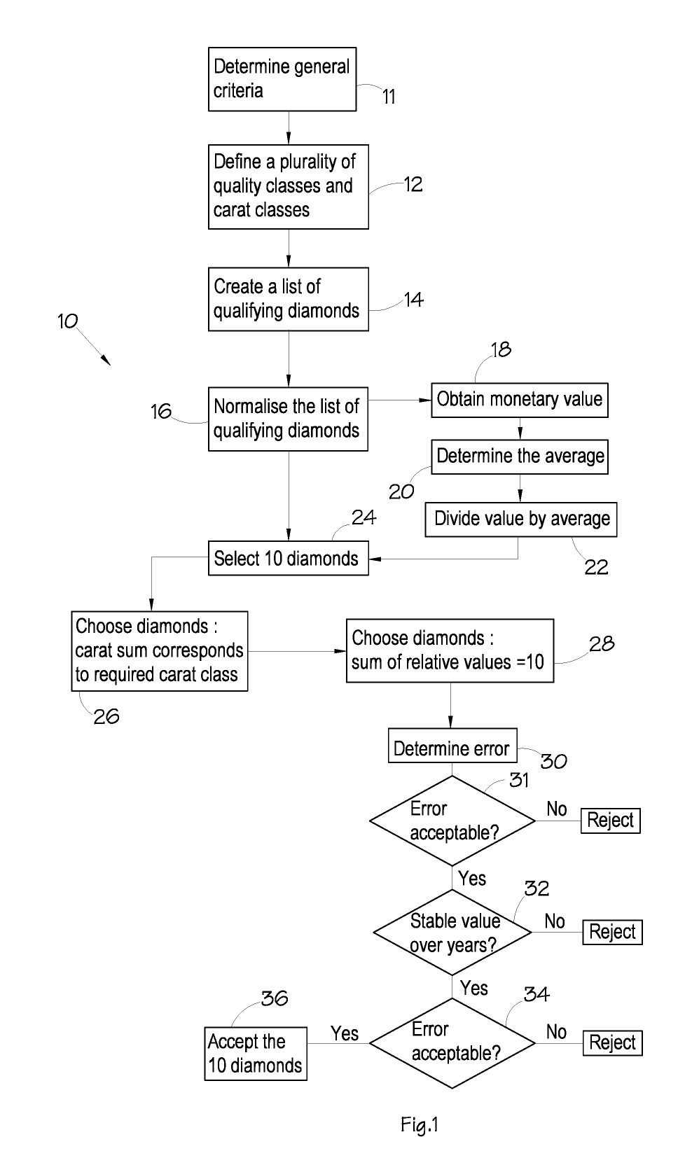

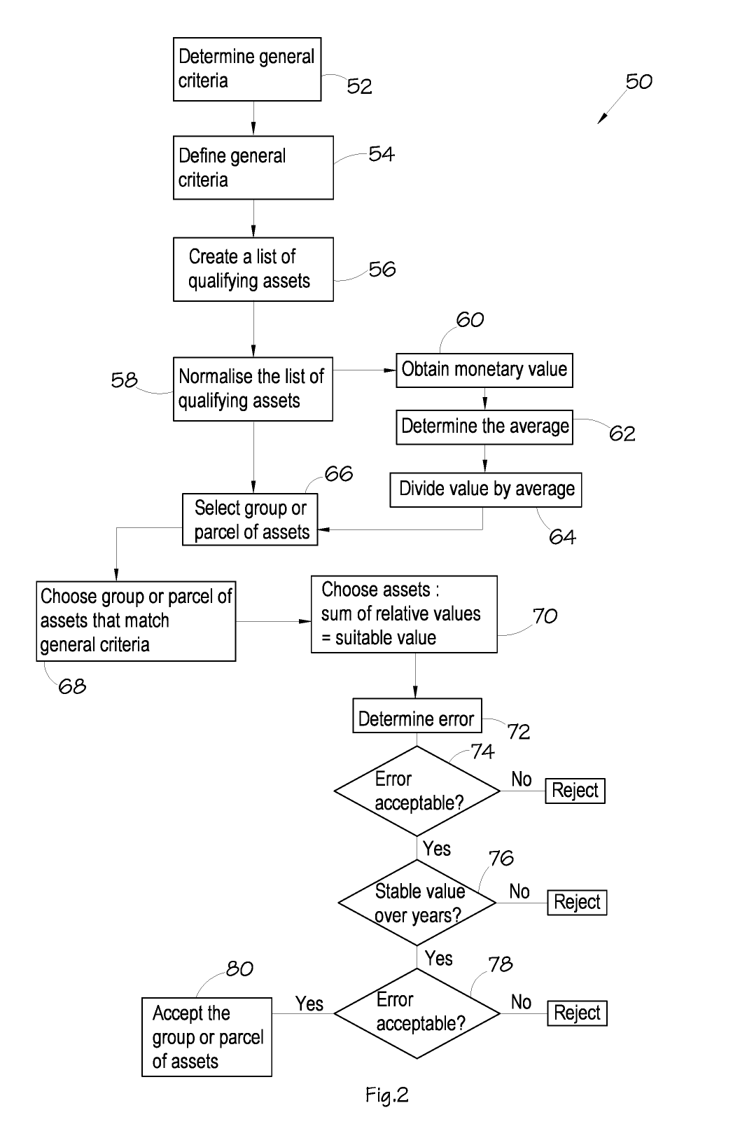

Referring to FIG. 1, a method 10 of creating a standard unit of value for non-uniform commodities, in this example diamonds (in which case the unit may be referred to as a Diamond Currency Unit (DCU), is shown. A more generic version in respect of non-uniform assets of objects is described further below with reference to FIG. 2.

The method 10 comprises an initial step, indicated by block 11, of determining the general criteria that drive value and that may be used with reference to the relevant object, in this case, diamonds. As indicated above, with respect to diamonds in particular, the general criteria may be the four C's (carat, clarity, colour, and cut).

The method 10 then proceeds to define a plurality of quality classes (for example, alpha, beta, gamma and delta, with reference to Table 1 above), and a plurality of carat classes (for example 3.5, 5, 10 and 20, with reference to Table 3 above), as indicated by block 12. This may be done for a particular diamond cut, and in this regard the ‘brilliant-cut’ may be utilized (although other diamond cuts could be used).

For each combination of quality class and carat class, a list of all possible diamonds is created, as indicated by block 14. For example, in the 5-alpha mass class (i.e. 5 carat diamond, alpha quality (with reference to Table 1)) there are 11 possible carat values (ranging from 0.45 to 0.55 in 0.01 increments) and 9 different qualities of diamonds, giving 99 possible diamonds to choose from.

The value of the diamonds in the list of possible diamonds over a plurality of years is then normalised, as indicated by block 16. This may be done by obtaining or determining the (dollar) monetary value for each of the diamonds in the list as indicated by block 18. The values are typically obtained from a generally accepted market table, for practical purposes a report such as the Rapaport table, and is done for a plurality of years (or at least a sufficiently long period to capture the drivers of value), per year, such as for example the 10 years between 2005 and 2014. The average of all these values is then determined, as indicated by block 20. Each value in the list is then divided by the average so as to obtain an average relative value for each diamond in the list, as indicated by block 22.

A group of ten (for example) diamonds is then selected that collectively define the standard unit of value (i.e. the DCU), as indicated by block 24. This step 24 of selecting the group of diamonds includes choosing diamonds from the diamond list such that the carat sum of ten diamonds corresponds to the required carat class (typically, but not limited to 3.5, 5, 10 or 20), as indicated by block 26.

The chosen ten diamonds are then checked to ensure that the sum of the relative values of the ten diamonds, according the average relative value list over the fixed period, is very close to ten, as indicated by block 28. This involves comparing the sum of the relative values of the ten diamonds to ten, and determining whether the difference is an allowable difference or not, as indicated by block 30.

For example if the sum of the relative values of the 10 diamonds is 10.003, then the difference is |10.003−10|=0.003. This is the error on the target of 10. Given as a percentage, the error is (0.003/10)*100=0.03%. In another example, if the sum is 9.996, then the difference is |9.996−10|=0.004, which gives an error of 0.04%. In other words, a maximum allowable error is chosen for the created units, say e. The method is thus arranged to only accept sets of 10 diamonds that satisfy the condition that the error on the relative value sum is at most e, that is, the relative sum lies within the range 10−e to 10+e. In this way, all acceptable units have a relative value that is appropriately close and near-precise (and differ by at most 2e). The error may be defined in terms of percentages, such as an error of at most p %, in which case e=p/10.

In an embodiment, once the set of ten diamonds with an acceptable error in its relative value has been determined, as indicated by decision block 31, the method comprises checking to see whether the determined set of ten diamonds has a stable value over the corresponding plurality of years (i.e. 2005-2014, in this case) as indicated by block 32. This may be achieved by calculating, for each year in the plurality of years, the relative value of the ten diamonds (as described above in block 28). This may involve obtaining or determining the dollar monetary value for each of the ten diamonds, again, typically from the Rapaport table, determining the average of all these values; and dividing each value of the ten diamonds by the average so as to obtain an average relative value for each of the ten diamonds.

The error of the relative values for this set of ten diamonds for each year may then be calculated, and a determination made as to its acceptability, as indicated by block 34. This is similar to the step 30 defined above, which determines whether the difference is an allowable difference or not over the total fixed period (for example ten years), but functions as a ‘second verification’ to reject combinations which fall outside the accepted error margin as measured at any point in time within the fixed period (for example each one year within the ten years). For example, if the sum of the relative values is 10.05, the error is |10.05−10|=0.05, or 0.5%. Again, a maximum allowable error must be chosen for this set of ten diamonds to be accepted.

In an embodiment, the method concludes by accepting the ten diamonds if the set is accepted for each year in the plurality of years (e.g. 2004-2014) as indicated by block 36.

Simulations were run on certain classes of units (such as 3.5-alpha) to determine what choice of errors would lead to enough combinations of 10 diamonds that satisfy the criteria. If the acceptable error is too low, there may be too few acceptable combinations of cards. The simulations showed that the error in the average relative value list, when choosing the initial group of ten diamonds (i.e. step 30), is allowed to be relatively restrictive, such as around 0.002 (or 0.02%). However, the error in the average relative value list, when determining whether the determined set of ten diamonds (i.e. step 34) has a stable value over the plurality of years, may be less restrictive, such as around 0.02 (or 0.2%).

As indicated above, there may be four unit weight classes namely, 3.5, 5, 10 and 20 carats. Each weight class may include four quality classes known as alpha (α), beta (β), gamma (γ) and delta (δ). The following represent examples of the units available—3.5 alpha, 3.5 beta etc.; 5 gamma, 5 delta etc.; 10 alpha etc.; 20 delta etc. In total, there are sixteen individual units or mass groups, each containing ten diamonds, each having its own associated matrix. A matrix is a mathematical object whose entries are described by their position in a row and a column. The notation used for these matrix entries is ij which denotes that the entry is found in row i and column j. To denote the matrices, the following notation may be used: R_{q}^{p} ij, where ij is as above and the superscript p denotes the year under consideration while the subscript q represents the carat weight and class.

For the purposes of the algorithm of the invention, the rows represent the colour grading of a matrix while the columns represent the clarity grading, as shown in Table 1 above. Each class has a carat range associated with it. Hence, any diamond will be assigned an ordered triple (colour, clarity, carat) with the first two numbers being indicative of the position of the diamond within its associated matrix. The carat value is denoted by car.

Again with reference to Table 1, the alpha-class comprises stones in the colour range D, E, F and clarity range FL/IF, VVS1, VVS2. Stones in the beta-class have the same colour range as the alpha-class but the clarity range is VS1, VS2, S11, S12. The colour range for both the gamma- and delta-classes is the same, namely G, H, I, J. However, the clarity grading of the gamma-class is the same as that of the alpha-class, while the delta-class has the same clarity gradings as the beta-class.

The carat weight ranges, as set out in Table 3, are as follows:

3.5 carat range is 0.30-0.39;

5.0 carat range is 0.45-0.55;

10 carat range is 0.92-1.12;

20 carat range is 1.75-2.25.

Using historical data from the Rapaport (Rap) sheets, the associated matrices can be completed for the given time period, in this case, 10 years. This means that there are ten ‘historical’ matrices for each unit or mass group. Depending on how the data is obtained from the historical sheets, there are then two cases to consider. For the purpose of this illustration, a 3.5 carat card which is associated with a 3×3 matrix has nine entries ij where 1≤i≤3 and 1≤j≤3.

Consider the case in which the data comes from a single alpha table on the Rapaport sheets, for example, 3.5 carats and the year 2005. The Rapaport numbers may be entered into their appropriate row and column positions ij in the 3×3 grid shown below:

| | IF | VVS1 | VVS2 |
|---|---|---|---|
| D | 47 | 41 | 36 |
| E | 42 | 38 | 34 |
| F | 39 | 36 | 31 |

The above example table may be denoted by R_{3.5α}²⁰⁰⁵ ij. The superscript indicates the year under consideration while the subscript gives the carat value and class. The average value is then determined, say Av_{3.5α}²⁰⁰⁵ of all the entries ij in matrix R_{3.5α}²⁰⁰⁵ ij. That is, the nine ij values in this matrix are summed, which number is then divided by nine to obtain

$$\frac{47 + 41 + 36 + 42 + … + 36 + 31}{9} = 38.22222 .$$

More generally, this is given by

$${Av}_{3.5 α}^{2005} = \frac{sum of Rap values of all α \text{-} stones in 3.5 range}{number of stones in class}$$

This is repeated for all 10 years' worth of data, yielding the following table:

| Year | R_{3.5α}^{year}11 | R_{3.5α}^{year}12 | R_{3.5α}^{year}13 | R_{3.5α}^{year}21 | R_{3.5α}^{year}22 | R_{3.5α}^{year}23 | R_{3.5α}^{year}31 | R_{3.5α}^{year}32 | R_{3.5α}^{year}33 | Av_{3.5α}^{year} |
|---|---|---|---|---|---|---|---|---|---|---|
| 2005 | 47 | 41 | 36 | 42 | 38 | 34 | 39 | 36 | 31 | 38.22 |
| 2006 | 46 | 39 | 34 | 40 | 36 | 32 | 37 | 34 | 29 | 36.33 |
| 2007 | 46 | 38 | 33 | 39 | 34 | 30 | 36 | 33 | 28 | 35.22 |
| 2008 | 46 | 38 | 33 | 39 | 35 | 30 | 36 | 33 | 28 | 35.33 |
| 2009 | 45 | 37 | 32 | 38 | 34 | 29 | 36 | 33 | 27 | 34.55 |
| 2010 | 45 | 37 | 32 | 38 | 34 | 29 | 36 | 33 | 27 | 34.55 |
| 2011 | 45 | 37 | 32 | 38 | 34 | 29 | 36 | 33 | 27 | 34.55 |
| 2012 | 45 | 38 | 33 | 38 | 34 | 30 | 34 | 31 | 27 | 34.44 |
| 2013 | 44 | 36 | 31 | 36 | 32 | 28 | 32 | 29 | 25 | 32.55 |
| 2014 | 43 | 35 | 32 | 35 | 31 | 29 | 31 | 29 | 27 | 32.44 |

A second table ^{˜}R_{3.5α}²⁰⁰⁵ ij is then constructed for each year, called the relative Rap table. The entries in this table are obtained by dividing the entries in R_{3.5α}²⁰⁰⁵ ij by the average value Av_{3.5α}²⁰⁰⁵ just calculated, and which appears in the column on the right. So for 2005, the results are as follows:

| | [symbol] R_{3.5α}²⁰⁰⁵11 | [symbol] R_{3.5α}²⁰⁰⁵12 | [symbol] R_{3.5α}²⁰⁰⁵13 | [symbol] R_{3.5α}²⁰⁰⁵21 | [symbol] R_{3.5α}²⁰⁰⁵22 |
|---|---|---|---|---|---|
| 2005 | 1.23 | 1.07 | 0.94 | 1.10 | 0.99 |

| | [symbol] R_{3.5α}²⁰⁰⁵23 | [symbol] R_{3.5α}²⁰⁰⁵31 | [symbol] R_{3.5α}²⁰⁰⁵32 | [symbol] R_{3.5α}²⁰⁰⁵33 |
|---|---|---|---|---|
| 2005 | 0.89 | 1.02 | 0.94 | 0.81 |

Thus an entry in ^{˜}R_{3.5α}²⁰⁰⁵ (i,j) has the general form:

$${}_{}^{\sim}{R}{}_{3.5 α}^{2005} ( i , j ) = \frac{{R}_{3.5 α}^{2005} ( i , j ) \text{?}}{{Av}_{3.5 α}^{2005}}$$

$$\text{?} \text{indicates text missing or illegible when filed}$$

The resulting table of relative values is shown below:

| | [symbol] R_{3.5α}^{year}11 | [symbol] R_{3.5α}^{year}12 | [symbol] R_{3.5α}^{year}13 | [symbol] R_{3.5α}^{year}21 | [symbol] R_{3.5α}^{year}22 | [symbol] R_{3.5α}^{year}23 | [symbol] R_{3.5α}^{year}31 | [symbol] R_{3.5α}^{year}32 | [symbol] R_{3.5α}^{year}33 |
|---|---|---|---|---|---|---|---|---|---|
| 2005 | 1.23 | 1.07 | 0.94 | 1.10 | 0.99 | 0.89 | 1.02 | 0.94 | 0.81 |
| 2006 | 1.27 | 1.07 | 0.94 | 1.10 | 0.99 | 0.88 | 1.02 | 0.94 | 0.80 |
| 2007 | 1.31 | 1.08 | 0.94 | 1.11 | 0.97 | 0.85 | 1.02 | 0.94 | 0.79 |
| 2008 | 1.30 | 1.08 | 0.93 | 1.10 | 0.99 | 0.85 | 1.02 | 0.93 | 0.79 |
| 2009 | 1.30 | 1.07 | 0.93 | 1.10 | 0.98 | 0.84 | 1.04 | 0.95 | 0.78 |
| 2010 | 1.30 | 1.07 | 0.92 | 1.10 | 0.98 | 0.84 | 1.04 | 0.95 | 0.78 |
| 2011 | 1.30 | 1.07 | 0.92 | 1.10 | 0.98 | 0.84 | 1.04 | 0.95 | 0.78 |
| 2012 | 1.31 | 1.10 | 0.96 | 1.10 | 0.99 | 0.87 | 0.99 | 0.90 | 0.78 |
| 2013 | 1.35 | 1.10 | 0.95 | 1.10 | 0.98 | 0.86 | 0.98 | 0.89 | 0.76 |
| 2014 | 1.33 | 1.08 | 0.99 | 1.08 | 0.96 | 0.89 | 0.96 | 0.89 | 0.83 |

Finally the entries in the matrix R_{3.5}* (i,j) are calculated by averaging the tilde values for each entry (i,j) over the 10 years (i.e. find the average of each column in the table above) to obtain:

| R_{3.5α}*11 | R_{3.5α}*12 | R_{3.5α}*13 | R_{3.5α}*21 | R_{3.5α}*22 | R_{3.5α}*23 | R_{3.5α}*31 | R_{3.5α}*32 | R_{3.5α}*33 |
|---|---|---|---|---|---|---|---|---|
| 1.30 | 1.08 | 0.94 | 1.10 | 0.98 | 0.86 | 1.01 | 0.93 | 0.79 |

So an entry in R_{3.5}* has the general form

$${R}_{3.5 α}^{*} ( i , j ) = \frac{{}_{}^{-}{R}{}_{3.5 α}^{2005} + {}_{}^{-}{R}{}_{3.5 α}^{2006} + … + {}_{}^{-}{R}{}_{3.5 α}^{2014}}{number of years} ,$$

and represents a combination of the colour and the clarity. In order to introduce the carat value we construct a table of R_{3.5}* (i,j) and stone sizes as follows:

| | R_{3.5α}*11 | R_{3.5α}*12 | R_{3.5α}*13 | R_{3.5α}*21 | R_{3.5α}*22 | R_{3.5α}*23 | R_{3.5α}*31 | R_{3.5α}*32 | R_{3.5α}*33 |
|---|---|---|---|---|---|---|---|---|---|
| 0.30 | 0.39 | 0.324 | 0.282 | 0.33 | 0.294 | 0.26 | 0.3 | 0.279 | 0.237 |
| 0.31 | 0.4 | 0.335 | 0.291 | 0.341 | 0.304 | 0.27 | 0.31 | 0.288 | 0.245 |
| 0.32 | 0.42 | 0.346 | 0.301 | 0.33 | 0.314 | 0.28 | 0.32 | 0.298 | 0.253 |
| 0.33 | 0.43 | 0.356 | 0.31 | 0.363 | 0.323 | 0.28 | 0.33 | 0.307 | 0.261 |
| 0.34 | 0.44 | 0.367 | 0.32 | 0.374 | 0.333 | 0.29 | 0.34 | 0.316 | 0.269 |
| 0.35 | 0.46 | 0.378 | 0.329 | 0.385 | 0.343 | 0.3 | 0.35 | 0.326 | 0.277 |
| 0.36 | 0.47 | 0.36 | 0.338 | 0.396 | 0.353 | 0.31 | 0.36 | 0.335 | 0.284 |
| 0.37 | 0.48 | 0.4 | 0.348 | 0.407 | 0.363 | 0.32 | 0.37 | 0.344 | 0.292 |
| 0.38 | 0.49 | 0.41 | 0.357 | 0.418 | 0.372 | 0.33 | 0.38 | 0.353 | 0.3 |
| 0.39 | 0.51 | 0.421 | 0.367 | 0.429 | 0.382 | 0.34 | 0.39 | 0.363 | 0.308 |

The table above provides nine faces containing all the 90 available choices and the entries represent the relative value of each stone.

To build up a combined unit (i.e. DCU) of 10 stones, we require (col₁, cla₁, car₁), . . . , (col₁₀, cla₁₀, Car₁₀) where (colᵢ, claᵢ, carᵢ) denote respectively, the colour, clarity and carat weight associated with stone i. Furthermore, if we sum the carat weights then we get exactly 3.5 that is,

Σᵢ₌₁¹⁰carᵢ=3.5

If, for example, a 10-carat unit had been chosen, then the above sum would have been exactly 10. Thus, given the information on the colour and clarity pertaining to a particular stone i say, it is possible to calculate the relative value of the stone i by forming the product

Rvᵢ=R_{3.5α}*(col₁,cla₁,car₁), . . . , (col₁₀,cla₁₀,car₁₀)

where

|Σᵢ₌₁¹⁰Rvᵢ−3.5|<ε.

Using the same set of ten stones (col1, cla1, car1), . . . , (col10, cla10, car10), and then calculate on any of the previous relative Rap sheets for each of the ten years. If the values obtained are close to 3.5 it means that there is no significant change in the value over the 10 year period, which in turn, means that the value is consistent.

In the case of 5 carats and in the beta-class, for example, the data is collected over two Rapaport tables, for example the values for 0.45, . . . , 0.49 come from one table and the values for 0.5, . . . 0.57 from a second table. In this instance, we have the following 13 sizes:

0.45, 0.46, 0.47 . . . 0.56, 0.57.

A list may be compiled by multiplying each matrix entry (i.e. each Rap value) by each of the sizes in the range. For example, the entry (1,1) would have the following list

L_{5β}²⁰⁰⁵(1,1)=R_{5β}²⁰⁰⁵(1,1)(0.45), R_{5β}²⁰⁰⁵(1,1)(0.46), . . . , R_{5β}²⁰⁰⁵(1,1)(0.57).

Similarly,

L_{5β}²⁰⁰⁵(2,1)=R_{5β}²⁰⁰⁵(2,1)(0.45), R_{5β}²⁰⁰⁵(2,1)(0.46), . . . , R_{5β}²⁰⁰⁵(2,1)(0.57),

Let V_{5β}²⁰⁰⁵ be comprised of all lists L_{5β}²⁰⁰⁵ (i,j for all (i,j) in the class, that is

V_{5β}²⁰⁰⁵=L_{5β}²⁰⁰⁵(1,1), . . . , L_{5β}²⁰⁰⁵(3,4).

Then determine the average of all entries in V_{5β}²⁰⁰⁵ and call it AvV_{5β}²⁰⁰⁵. Then divide each entry in the list by AvV_{5β}²⁰⁰⁵ to get

$${}_{}^{\sim}{V}{}_{5 β}^{2005} ( i , j ) = \frac{1}{{AvV}_{5 β}^{2005}} \text{?} . \\ \text{?} \text{indicates text missing or illegible when filed}$$

Suppose that the tilde list entries are represented as follows:

^{˜}V_{5β}²⁰⁰⁵=[m₁²⁰⁰⁵,m₂²⁰⁰⁵,m₃²⁰⁰⁵, . . . ]

^{˜}V_{5β}²⁰⁰⁶=[m₁²⁰⁰⁶,m₂²⁰⁰⁶,m₃²⁰⁰⁶, . . . ]

.

.

.

^{˜}V_{5β}²⁰¹⁴=[m₁²⁰¹⁴,m₂²⁰¹⁴,m₃²⁰¹⁴, . . . ]

If M₁ is the average of all 10 first entries in ^{˜}V_{5β}²⁰⁰⁵, ^{˜}V_{5β}²⁰⁰⁶, . . . , ^{˜}V_{5β}²⁰¹⁴ then the relative Rap value are given by

V*_{5β}(colᵢ,claᵢ,carᵢ)=[M₁,M₂,M₃, . . . ]

where, more generally

$${M}_{k} = \frac{{m}_{k}^{2005} + {m}_{k}^{2006} + … + {m}_{k}^{2014}}{number of years} .$$

Once again,

Σᵢ₌₁¹⁰carᵢ=5 and |Σᵢ₌₁¹⁰Rvᵢ−10|<ε.

The same conclusion is reached as in the previous case, when taking the same set of ten stones (col₁, cla₁, car₁), . . . , (col₁₀, cla₁₀, car₁₀) and repeating the calculations on any of the previous relative Rap sheets for each of the ten years, the values obtained are close to 5. This means that there is no significant change in the value over the years, which in turn, means that the value is consistent.

The results suggest that, even for small values of c there is a substantial number of possible unit combinations. If the carat range is not too large the collection of all possible sets of 10 may be calculated and stored in a database, which will enable fast search.

When selecting a set of 10 stones (e.g. diamonds) to make up a DCU unit, there is a very large number of possible combinations to consider. For example, if there are 16 different quality (i.e., colour/clarity) classes and 10 different carat values, this gives 160 choices of stone, which in turn gives 10¹⁶⁰ different combinations. However, most of these will not satisfy the requirements above, namely that, for 5β say,

Σᵢ₌₁¹⁰carᵢ=5 and |Σᵢ₌₁¹⁰Rvᵢ−10|<ε.

However, it is still required to search through all combinations to find suitable ones. Some optimization is possible, but the number of possibilities is still very large, creating a computational problem. For this reason, the range of carat values for a particular class should not be too large.

A number of simulations were run for various card classes to calculate the number of possible unit combinations that satisfy the above conditions, that is, that for unit 5β, for example:

Σᵢ₌₁¹⁰carᵢ=5 and |Σᵢ₌₁¹⁰Rvᵢ−10|<ε.

Consider the problem of creating a card for one of the 16 classes that satisfies the above requirements, with the interest being in class 5β, and suppose that k stones have already been selected where k<10. Then for these k stones there is a carat sum, say Cₖ, and a relative value sum, say Rvₖ. Another 10−k stones is required such that the carat sum of these 10−k stones, denoted C₁₀₋ₖ, is 5−Cₖ, and the relative value sum of these 10−k stones, denoted Rv₁₀₋ₖ, satisfies |Rvₖ+Rv₁₀₋ₖ|<ε, where ε is our “margin of error.” We also require that −ε−Rvₖ<Rv₁₀₋ₖ<ε−Rvₖ. Given these requirements, a search through all possible combinations of these 10−k stones that satisfy the required conditions can be done. The smaller the number of remaining stones, the quicker the search will be. However, if the collection of all possible combinations of 10 stones (for each particular class) is stored in a database, then the search for possible combinations will be significantly faster.

As described above, 16 standard units of value (i.e. the 16 DCUs or mass groups) have been defined and created within a mathematically sound valuation methodology, backed by the underlying physical asset, namely natural diamonds. For each unit, there is a fixed set of possible combinations (matrix) which fall within the accepted error margin, allowing for each unit of a unit class to be interchangeable and appropriately equal in value, the excepted error margin being negligible. These combinations of stones are mathematically finite at this point in time (based on the historical Rapaport data) and is therefore restricted. The result is that an Alpha 10 carat DCU unit is always interchangeable/or tradable against or with another Alpha 10 carat DCU unit, regardless of when it was manufactured into a unit. This principle applies on exactly the same basis for the other DCU unit types.

Thus, a methodology is provided to standardise non-uniform objects by creating units that each combine 10 of the objects, so that each combination of 10 objects is substantially equal in value to another unit of 10 objects within a defined group, with an acceptable to negligible error margin so that it can be ignored.

In particular, the methodology creates or sets a standard to value non-uniform commodities (for example diamonds, but not limited to diamonds only).

Thus, a weighted or relative value is ascribed to obtain a list of “relative values”, so that the comparison is made between a sum of relative values in one group and a sum of relative values in another group. The relative values are then normalised over a 10 year (or reasonable period) and checked over a fixed period of time to ensure stability, with combinations outside the accepted error margin being rejected. Once the groups of 10 diamonds are determined, they are checked again by comparing them against the average relative values obtained in any previous year. In addition, the methodology ensures that the groups that fall within the accepted error margin do so without creating any advantage to any one grouping of weight and quality range so as to ensure that there is no spike in demand for a particular stone.

Further, with the described methodology, the standard is set, by using a list of relative values that are then normalized over time. The USD$ value of each group would then be driven by the market and not the USD$ value of individual stones at a particular moment in time.

Referring to FIG. 2, a more generalised version of the methodology is shown, comprising a method 50 of creating a standard unit of value for non-uniform assets, for example other non-uniform commodities, etc. The method 50 comprises an initial step, indicated by block 52, of determining the general criteria that drive value and that may be used with reference to the relevant object or asset.

The method 50 then includes the step of defining, for a particular non-uniform asset, general criteria that drive value, as indicated by block 54.

The method 50 then includes the step of creating or identifying a list of all qualifying assets, as indicated by block 56.

The method 50 then includes the step of normalising the value of the assets in the list of possible assets over a fixed period, sufficient to measure changes of value, as indicated by block 58. This is typically done by obtaining or determining the monetary value for each of the assets in the list, as indicated by block 60, determining the average of all these values, as indicated by block 62, and dividing each value in the list by the average so as to obtain an average relative value for each asset in the list, as indicated by block 64.

The method 50 then includes the step of selecting a group or parcel of assets that collectively define the standard unit of value, as indicated by block 66.

In an embodiment, the step of selecting the group of assets includes choosing a group of assets, typically a plurality of assets, from the asset list such that they match the defined general criteria, as indicated by block 68.

The method 50 then further includes the step of choosing the groups of assets such that the sum of the relative values over the fixed period of each group of assets, according to the average relative value list, is substantially the same or identical. This involves comparing the sum of the relative values of the assets to a suitable value, as indicated by block 70, and determining whether the difference is an allowable difference or not, as indicated by blocks 72 and 74.

In an embodiment, once the set of assets with an acceptable error in its relative value has been determined, the method 50 comprises in addition checking, over a fixed period of time, whether the determined set of assets does not deviate beyond an acceptable error margin at any point in time during the fixed period of time, as indicated by block 76. This may be achieved, for example, by calculating, for each year within the fixed period of time, the relative value of the group or parcel of assets and the error of the relative values of the group or parcel of assets for each year during that period of time, as indicated by block 78.

In an embodiment, the method concludes by accepting the group or parcel of assets if the set is accepted for each year within the fixed period of time, as indicated by block 80.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

The flow chart sequences are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various embodiments, of ±1%, ±5%, ±10%, or ±20%.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method of creating a standard unit of value for diamonds, the method comprising:
defining, for a particular diamond cut, a plurality of quality classes and a plurality of carat classes;
for each of a plurality of combinations where each combination comprises one of the plurality of quality classes and one of the plurality of carat classes, creating a list of qualifying diamonds;
normalising a value of the diamonds in the list of qualifying diamonds over a fixed period sufficient to measure changes of value, wherein normalizing the value comprises:
determining a plurality of monetary values comprising a monetary value for each qualifying diamond in the list of qualifying diamonds;
determining an average of the plurality of monetary values; and
dividing each monetary value in the list by the average to obtain an average relative value for each qualifying diamond in the list of qualifying diamonds, and
selecting a group of diamonds that collectively define the standard unit of value.

2. The method of claim 1, wherein the step of selecting the group of diamonds comprises choosing a group of diamonds from the list of qualifying diamonds such that the carat sum of the group of diamonds corresponds to a required carat class.

3. The method of claim 2, wherein the step of selecting the group of diamonds further comprises choosing the group of diamonds such that a sum of the relative values over the fixed period of each group of diamonds, according to the average relative value list, is substantially the same or identical.

4. The method of claim 3, wherein the group of diamonds incudes ten diamonds and the method further comprises:
comparing the sum of the relative values of the ten diamonds to ten; and
determining whether the difference is an allowable difference or not.

5. The method of claim 4, wherein once the set of ten diamonds with an acceptable error in its relative value has been determined, the method comprises checking, over a fixed period of time, whether the determined set of ten diamonds does not deviate beyond an acceptable error margin at any point in time during the fixed period of time.

6. The method of claim 5, comprising calculating, for each year within the fixed period of time, the relative value of the ten diamonds and the error of the relative values of the ten diamonds for each year.

7. The method of claim 6, wherein the method further comprises accepting the ten diamonds if the set is accepted for each year in the plurality of years.

8. A method of creating a standard unit of value for non-uniform assets, the method comprising:
defining, for a particular non-uniform asset, general criteria that drive value;
creating a list of all qualifying assets based on the general criteria;
normalising a value of the assets in the list of qualifying assets over a fixed period, sufficient to measure changes of value, wherein normalising the value comprises:
determining a plurality of monetary values comprising a monetary value for each of the qualifying assets in the list of qualifying assets;
determining an average of the plurality of monetary values; and
dividing each monetary value in the list by the average to obtain an average relative value for each qualifying asset in the list of qualifying assets, and
selecting a group of assets that collectively define the standard unit of value.

9. A method of identifying a group of diamonds that define a standard unit of value, the method comprising:
selecting the group of diamonds that collectively define the standard unit of value, wherein the standard unit value is created by:
defining, for a particular diamond cut, a plurality of quality classes and a plurality of carat classes;
for each of a plurality of combinations where each combination comprises one of the plurality of quality classes and one of the plurality of carat classes, creating a list of qualifying diamonds;
normalising a value of the diamonds in the list of qualifying diamonds over a fixed period sufficient to measure changes of value, wherein normalizing the value comprises:
determining a plurality of monetary values comprising a monetary value for each qualifying diamond in the list of qualifying diamonds;
determining an average of the plurality of monetary values; and
dividing each monetary value in the list by the average to obtain an average relative value for each qualifying diamond in the list of qualifying diamonds.
